(19) United States
(12) Patent Application Publication
(10) Pub. No.: US 2018/0071995 A1
(43) Pub. Date: Mar. 15, 2018

(54) THERMOPLASTIC RESIN FILM LAMINATE AND MOLDED ARTICLE COMPRISING THERMOPLASTIC RESIN FILM LAMINATE

(71) Applicants: MITSUBISHI GAS CHEMICAL COMPANY, INC., Tokyo (JP); MGC FILSHEET CO., LTD., Saitama (JP)

(72) Inventor: Haruhiko KUROKAWA, Kanagawa (JP)

(73) Assignees: MITSUBISHI GAS CHEMICAL COMPANY, INC., Tokyo (JP); MGC FILSHEET CO., LTD., Saitama (JP)

(21) Appl. No.: 15/559,184

(22) PCT Filed: Mar. 24, 2016
(86) PCT No.: PCT/JP2016/059387

§ 371 Date: Sep. 18, 2017

(30) Foreign Application Priority Data
Mar. 25, 2015 (JP) 2015-062837

(51) Int. Cl. B29C 65/00; B29C 65/08

(52) U.S. Cl. CPC B29C 66/5346; B29L 2022/00; B29C 65/08

(57) ABSTRACT

Provided is a thermoplastic resin film laminate, which is obtained by ultrasonic welding of a thermoplastic resin film and a thermoplastic resin molded article, and which has high welding strength and excellent appearance with less welding marks. The above-described problem is solved by a thermoplastic resin film laminate which is obtained by bonding, by ultrasonic welding, a thermoplastic resin film having a thickness of 0.4 mm or less and a welding margin of a thermoplastic resin molded article having the welding margin and having a thickness of 0.5 mm or more, and wherein the height of the welding margin is 75-125% of the thickness of the thermoplastic resin film.

### TECHNICAL FIELD

The present invention relates to a resin laminate obtained by ultrasonic welding of a thin thermoplastic resin film and a thermoplastic resin molded article, etc.

### BACKGROUND ART

Recently, higher design properties have been desired for members of electrical and electronic equipments because reduction in size of products and reduction in thickness of components have been advanced. In particular, regarding cases for battery packs in which a small rechargeable battery is installed, reduction in thickness of plastic molded articles has been advanced for the purpose of increase in capacity. Regarding the thickness of the case for battery packs, it is said that a portion with a thickness of 0.4 mm or less will account for 40% or more of the surface area of the molded article because reduction in thickness of members will be continuously advanced.

Examples of methods for obtaining such a thin molded article that have been employed include a usual injection molding method and an injection molding method using an in-mold film, in which a thin film is set in a mold in advance and then injection molding is performed, as described in Patent Document 1. However, in the usual injection molding method, it is difficult to fill a thin portion with a resin, resulting in short shot of a product, and in the case of filling by high injection pressure, a thin portion of a molded article becomes warped. Further, in the injection molding method using an in-mold film described in Patent Document 1, in the case of a molded article having an opening, a film covering the opening is warped due to the difference of heat shrinkage between a contact portion between the molded article and the film and a non-contact portion therebetween.

There are also other methods including a method of bonding a film to an injection-molded article using an additive or double-sided tape. However, according to any method, good outer appearance cannot be obtained because the thickness of the bonded portion locally increases.

Examples of other bonding methods for molded articles, etc. include ultrasonic welding methods utilizing friction between molded articles described in Patent Documents 2 and 3. However, in the case of bonding between resins by means of ultrasonic welding methods, in general, the mainstream is bonding between thick injection-molded articles, and when a welding test is conducted with a film and a thick injection-molded article, poor outer appearance is easily caused due to welding defects generated at the time of contact between the film and the molded article.

### PRIOR ART DOCUMENTS

### Patent Documents

Patent Document 1: Japanese Laid-Open Patent Publication No. 2013-129077
Patent Document 2: Japanese Patent No. 4558374
Patent Document 3: Japanese Laid-Open Patent Publication No. S62-54757

### SUMMARY OF THE INVENTION

### Problems to be Solved by the Invention

The problem to be solved by the present invention is to provide a thermoplastic resin film laminate, which is obtained by ultrasonic welding of a thermoplastic resin film and a thermoplastic resin molded article, and which has high welding strength and excellent appearance with less welding marks.

### Solution to Problem

The present inventors diligently made researches in order to solve the above-described problem, focused attention on the difference between the thermal deformation temperature of the thermoplastic resin film and that of the thermoplastic resin molded article and the height of a welding margin (energy director) placed on the surface of the thermoplastic resin molded article, and achieved a balance between good outer appearance and welding strength of film-welded articles, which conventionally had difficulty.

Specifically, the present invention relates to a thermoplastic resin film laminate obtained by ultrasonic welding of a thermoplastic resin film and a thermoplastic resin molded article as shown below:

[1] A thermoplastic resin film laminate, which is obtained by ultrasonic welding, a thermoplastic resin film (A) having a thickness of 0.4 mm or less and a welding margin (C) of a thermoplastic resin molded article (B) having the welding margin (C) and having a thickness of 0.5 mm or more, wherein the height of the welding margin (C) is 72 to 130% of the thickness of the thermoplastic resin film (A), and wherein the difference between the thermal deformation temperature of the thermoplastic resin film (A) and that of the thermoplastic resin molded article (B) is 20° C. or less.
[2] The thermoplastic resin film laminate according to item [1], wherein the thermoplastic resin film (A) and the thermoplastic resin molded article (B) are formed with the same type of resin materials.
[3] The thermoplastic resin film laminate according to item [1] or [2], wherein the thermoplastic resin film (A) has a thickness of 0.2 mm to 0.3 mm.
[4] The thermoplastic resin film laminate according to any one of items [1] to [3], wherein the thermoplastic resin molded article (B) has at least one opening of 3 cm² or more, and wherein at least a part of the opening is covered with the thermoplastic resin film (A).
[5] A molded article comprising the thermoplastic resin film laminate according to any one of items [1] to [4].

### Effects of the Invention

The thermoplastic resin film laminate of the present invention, which is obtained by ultrasonic welding of a thermoplastic film and a thermoplastic resin molded article, has excellent welding strength and good outer appearance. Therefore, the thermoplastic resin film laminate of the present invention can be suitably used, for example, as a case for electrical/electronic/office automation equipments, a case for battery packs or a transparent window/window frame-integrated molded article.

### BRIEF DESCRIPTION OF THE DRAWINGS

FIG. 1 is a schematic cross sectional view of a thermoplastic resin film and a thermoplastic resin molded article.

FIG. 2 shows a plan view (FIG. 2(A)) showing a state where openings of a thermoplastic resin molded article are covered with a thermoplastic resin film and a cross sectional view (FIG. 2(B)) taken along line II-II in FIG. 2(A), showing a side-surface shape of the thermoplastic resin molded article.

FIG. 3 is a plan view of a thermoplastic resin molded article different from that in FIG. 2.

FIG. 4 is a plan view in which regions I and II of the thermoplastic resin molded article in FIG. 3 are enlarged.

### DESCRIPTION OF EMBODIMENTS

Hereinafter, the present invention will be described in detail. Note that the present invention is not limited to the below-described embodiments, and can be arbitrarily changed and then carried out within a range in which the effects of the present invention are exerted.

### [Compositions of Thermoplastic Resin Film (A), Thermoplastic Resin Molded Article (B) and Welding Margin (Energy Director) (C) of Thermoplastic Resin Molded Article]

The thermoplastic resin contained in the resin composition of the present invention is not particularly limited, and can be arbitrarily selected from substances conventionally used as molding materials. Examples thereof include a styrene-based resin, a polyphenylene ether-based resin, a polyolefin-based resin, a polyvinyl chloride-based resin, a polyamide-based resin, a polyester-based resin, a polycarbonate-based resin and an acrylic resin.

Examples of the styrene-based resin include a homopolymer of styrene, α-methylstyrene or the like, or a copolymer thereof, or a copolymer thereof with a copolymerizable unsaturated monomer. Specific examples thereof include a general purpose polystyrene (GPPS), a high impact polystyrene (HIPS), a heat-resistant polystyrene (e.g., α-methylstyrene polymer or copolymer), an acrylonitrile-butadiene-styrene copolymer (ABS), an acrylonitrile-butadiene-styrene-α-methylstyrene copolymer (α-methylstyrene-based heat-resistant ABS), an acrylonitrile-butadiene-styrene-phenylmaleimide copolymer (phenylmaleimide-based heat-resistant ABS), an acrylonitrile-styrene copolymer (AS), an acrylonitrile-chlorinated polystyrene-styrene-based copolymer (ACS), an acrylonitrile-ethylene propylene rubber-styrene copolymer (AES), an acryl rubber-acrylonitrile-styrene copolymer (AAS) and syndiotactic polystyrene (SPS). Further, the styrene-based resin may be a polymer blend.

Examples of the polyphenylene ether-based resin (PPE) include a homopolymer of poly(2,6-dimethyl-1,4-phenylene) ether, poly(2-methyl-6-ethyl-1,4-phenylene) ether or the like, and this homopolymer may be modified with the styrene-based resin.

Representative examples of the polyolefin-based resin include a homopolymer of an α-olefin such as ethylene, propylene, butene-1, 3-methylbutene-1, 3-methylpentene-1 and 4-methylpentene-1, or a copolymer thereof, or a copolymer thereof with another copolymerizable unsaturated monomer. Representative examples thereof include: polyethylenes such as a high-density polyethylene, a medium-density polyethylene, a low-density polyethylene, a linear low-density polyethylene, an ultra-high molecular weight polyethylene, and metallocene-based ethylene-α-olefin copolymers such as an ethylene-vinyl acetate copolymer, an ethylene-ethyl acrylate copolymer and an ethylene-octene-1 copolymer; polypropylenes such as an atactic polypropylene, a syndiotactic polypropylene, an isotactic polypropylene, a propylene-ethylene block copolymer, and a propylene-ethylene random copolymer; and polymethylpentene-1.

Examples of the polyvinyl chloride-based resin include a vinyl chloride homopolymer and a copolymer of vinyl chloride with a copolymerizable unsaturated monomer. Specific examples thereof include a vinyl chloride-acrylic acid ester copolymer, a vinyl chloride-methacrylic acid ester copolymer, a vinyl chloride-ethylene copolymer, a vinyl chloride-propylene copolymer, a vinyl chloride-vinyl acetate copolymer, and a vinyl chloride-vinylidene chloride copolymer. Further, the polyvinyl chloride-based resin may be chlorinated to increase the chlorine content thereof.

Examples of the polyamide-based resin (PA) include: resins obtained by ring-opening polymerization of a cyclic aliphatic lactam typified by 6-nylon (polyamide 6), 12-nylon, etc.; resins obtained by polycondensation of an aliphatic diamine and an aliphatic dicarboxylic acid such as 6,6-nylon, 6,10-nylon and 6,12-nylon; or in some cases, resins obtained by copolycondensation of an aromatic diamine and an aromatic dicarboxylic acid.

Examples of the polyester-based resin include resins obtained by polycondensation of an aromatic dicarboxylic acid and an alkylene glycol such as ethylene glycol, propylene glycol and butylene glycol. Specific examples thereof include polyethylene terephthalate (PET), polypropylene terephthalate (PPT) and polybutylene terephthalate (PBT).

Examples of the polycarbonate-based resin include a 4,4′-dihydroxydiarylalkane-based polycarbonate. Specific examples thereof include a bisphenol A-based polycarbonate (PC), a modified bisphenol-based polycarbonate, and a copolymer thereof.

Examples of the acrylic resin include a homopolymer of methacrylic acid ester or acrylic acid ester, or a copolymer thereof, or a copolymer thereof with another copolymerizable unsaturated monomer. Examples of monomers of methacrylic acid ester or acrylic acid ester include methyl esters, ethyl esters, n-propyl esters, isopropyl esters, and butyl esters of methacrylic acid or acrylic acid. Representative examples thereof include poly(methyl) methacrylate (PMMA).

### [Thermoplastic Resin Film (A)]

In the present invention, the thickness of the thermoplastic resin film (A) is 0.4 mm or less. This is the case where the surface area of the region in which the thickness is 0.4 mm or less is 70% or more of the surface area of the whole thermoplastic resin film. When the thickness of the thermoplastic resin film (A) is more than 0.4 mm, usually, it is easy to perform injection molding, and poor outer appearance caused by pressing of the energy director is not observed because the film is sufficiently thick, and therefore the effects of the present invention cannot be sufficiently obtained. The thickness of the thermoplastic resin film (A) is preferably 0.01 mm to 0.4 mm, more preferably 0.1 mm to 0.4 mm, and most preferably 0.2 mm to 0.3 mm. When the thickness of the thermoplastic resin film (A) is less than 0.01 mm, after performing ultrasonic welding, good outer appearance cannot be obtained because the film is too thin, and in the case of use as a case, internal components may not be sufficiently protected. As the thermoplastic resin film (A) of the present invention, a film produced according to a melt extrusion method using a T-die, a solvent casting method or a blow molding method can be used.

### [Thermoplastic Resin Molded Article (B)]

In the present invention, the average thickness of the thermoplastic resin molded article (B) is 0.5 mm or more. Examples of the method for molding the thermoplastic resin molded article (B) include injection molding, press molding, blow molding, extrusion molding, vacuum molding and pressure forming, but from the viewpoint of productivity, injection molding is preferably used.

In the thermoplastic resin film laminate of the present invention, the shape of the thermoplastic resin molded article (B) is not limited to a flat plate, and a three-dimensional shape may also be employed. As a particularly effective shape, a constitution in which the thermoplastic resin molded article (B) is a three-dimensional molded article, for example, a case, having an opening of 3 cm² or more, wherein the opening is covered with the thermoplastic resin film (A), is preferably used in the present invention. By covering the opening of the thermoplastic resin molded article (B) with the thermoplastic resin film (A), reduction in weight of members, for example, high packing density of components in the inside of the molded article (B) as a case can be realized.

### [Welding Margin (Energy Director) (C) of Thermoplastic Resin Molded Article]

The welding margin (energy director) (C) is provided to the welding surface of the thermoplastic resin molded article (B) in order to bond the thermoplastic resin film (A) to the thermoplastic resin molded article (B). As a bonding method, ultrasonic welding is used. When performing ultrasonic welding, ultrasonic energy is concentrated on the welding margin (energy director) provided to the thermoplastic resin molded article (B), and heat is generated by friction between the welding margin (C) of the thermoplastic resin molded article (B) and the thermoplastic resin film (A), thereby bonding the thermoplastic resin film (A) to the melted welding margin (energy director).

The energy director is convex toward the side of the thermoplastic resin film (A) to be bonded, i.e., the upper side, and the shape of the cross section of the energy director in the film thickness direction is preferably a triangle. Regarding this triangle of the cross section of the energy director, the apex angle thereof is 40° to 120°, preferably 50° to 70°, and most preferably 60°. Specifically, the cross-section shape is particularly preferably an equilateral triangle. When the cross-section shape of the welding margin (energy director) (C) is an triangle, in particular, an equilateral triangle, by performing ultrasonic welding, ultrasonic energy can be concentrated on the upper end, i.e., the apex of the triangle, while the region of the welding margin on the side of the thermoplastic resin molded article (B), i.e., the base side of the triangle, can be sufficiently provided. From this viewpoint, as the cross-section shape of the welding margin (energy director) (C), a quadrangle should be avoided, and in addition, a circular shape is preferably avoided. The shape of the welding margin (energy director) (C) can be provided by a method of transfer by means of injection molding or hot press molding using a mold, or mechanical cutting of the molded article, or processing by means of printing or the like.

Note that the welding margin (C) is preferably arranged continuously in a line on the welding surface of the thermoplastic resin molded article (B). It is particularly preferred that the welding margin (C) is arranged in a row on the welding surface of the thermoplastic resin molded article (B). This is because, when a plurality of rows of the welding margin (C), for example, a plurality of rows of the welding margin (C) parallel to each other are provided on the welding surface of the thermoplastic resin molded article (B), ultrasonic energy is distributed to the plurality of rows.

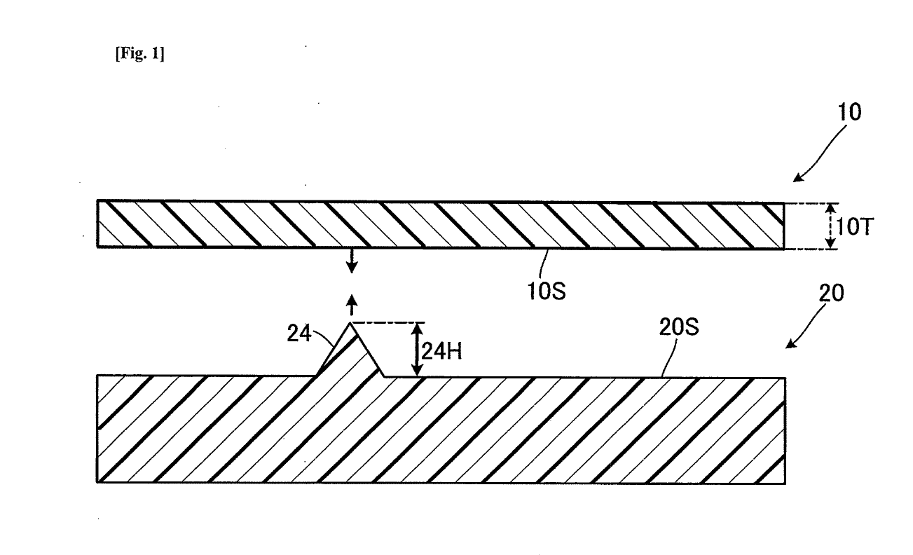

The height of the welding margin (energy director) (C), i.e., the length 24H from the welding surface 20S of the thermoplastic resin molded article (B) 20 to the top of the welding margin 24, whose cross-section shape is, for example, a triangle, as shown in FIG. 1 is preferably 72% to 130% of the thickness 10T of the thermoplastic resin film (A) 10. Specifically, when the thickness of the thermoplastic resin film (A) is represented by A (mm) and the height of the welding margin (C) is represented by C (mm),

the value obtained from C (mm)/A (mm)×100(%) is preferably 72% to 130%, and

the value obtained from (1−C (mm)/A (mm))×100(%) is preferably −28% to 30%.

The height 24H of the welding margin 24 is preferably 75 to 125%, more preferably 80 to 120%, and particularly preferably 85 to 115% of the thickness 10T of the thermoplastic resin film (A) 10. When the height 24H of the welding margin (energy director) exceeds the upper limit, though welding strength is obtained, poor outer appearance may be easily caused by pressing of the energy director. Further, when the height 24H of the welding margin (energy director) is lower than the lower limit, though a laminate having good outer appearance can be obtained, welding strength may be reduced.

As shown in FIG. 1, the thermoplastic resin film 10 and the thermoplastic resin molded article 20 are opposed to each other and subjected to ultrasonic welding for welding as shown by arrows, thereby forming a laminate of the thermoplastic resin film 10 and the thermoplastic resin molded article 20. Between the thermoplastic resin film 10 and the thermoplastic resin molded article 20 of the obtained laminate, the welding margin 24 is melted by ultrasonic welding to be a bonded portion which is melted in and mixed with the thermoplastic resin film 10. For this reason, in the bonded region between the thermoplastic resin film 10 and the thermoplastic resin molded article 20 of the produced laminate, each surface of these members is substantially smooth, and no problem associated with outer appearance is caused.

### [Thermal Deformation Temperatures of Thermoplastic Resin Film (A) and Thermoplastic Resin Molded Article (B)]

The thermal deformation temperatures of the thermoplastic resin film (A) and the thermoplastic resin molded article (B) of the present invention are glass transition temperatures when these resins are amorphous resins, and are melting points when these resins are crystalline resins. The thermal deformation temperatures can be measured by DSC (differential scanning calorimetry). In the case of incompatible-type polymer-alloy materials, thermal deformation temperatures of matrix resins are employed.

With respect to combined use of the thermoplastic resin film (A) and the thermoplastic resin molded article (B), the difference between the thermal deformation temperature of the thermoplastic resin film (A) and that of the thermoplastic resin molded article (B) is preferably 20° C. or less, more preferably 15° C. or less, and particularly preferably 10° C. or less. In particular, regarding the types of resins of the thermoplastic resin film (A) and the thermoplastic resin molded article (B), resins having high compatibility or high reactivity are preferably used. It is particularly preferred that the thermoplastic resin film (A) and the thermoplastic resin molded article (B) are formed with the same type of resin materials. As used herein, the same type of materials mean materials belonging to the same series of resins shown in paragraph [0013] and thereafter, and more specifically, thermoplastic resin materials having the same type of chemical bond. Therefore, in the present invention, resin materials having the same type of molecular structure are defined as the same type of resin materials even if the molecular weight, the type of copolymerization, the copolymerization composition ratio or the blending amount of additives of these resin materials are different.

In the case where the difference between the thermal deformation temperature of the thermoplastic resin film (A) and that of the thermoplastic resin molded article (B) exceeds 20° C., when priority is given to outer appearance, resin welding strength becomes insufficient, and when priority is given to welding strength, higher ultrasonic energy is required, and therefore a thermoplastic resin film laminate obtained (molded article) may have poor outer appearance.

### [Method for Producing Thermoplastic Resin Film Laminate]

In the method for producing the thermoplastic resin film laminate of the present invention, ultrasonic welding is used. Specifically, the thermoplastic resin film laminate is produced by ultrasonic welding of the thermoplastic resin film (A) and the welding margin (C) of the thermoplastic resin molded article (B). For example, the welding margin (C) is provided around the opening of the thermoplastic resin molded article (B), and the thermoplastic resin film (A) is bonded thereto to cover the opening, thereby obtaining the thermoplastic resin film laminate.

Thus, according to a production process in which the thickness of the thermoplastic resin film (A) is adjusted within a predetermined range and the welding margin (C) having a predetermined height is provided on the welding surface of the thermoplastic resin molded article (B), a laminate having high welding strength and good outer appearance can be obtained. In addition, by reducing the difference between the thermal deformation temperature of the thermoplastic resin film (A) and that of the thermoplastic resin molded article (B), a balance between high welding strength and good outer appearance can be surely achieved.

The thermoplastic resin composition to be used in the present invention may contain components other than those described above according to need, as long as desired physical properties are not significantly impaired. Examples of the other components include various resin additives such as a heat stabilizer typified by a phosphate and a phosphite, an antioxidant typified by a hindered phenol compound, an ultraviolet absorber typified by a benzotriazole-based compound, an antifog additive, an anti-blocking agent, a flowability improving agent, an impact strength improving agent, a sliding modifier, a plasticizer, a dispersing agent, an antimicrobial agent, a flame retardant, a glass fiber and a carbon fiber. One of these resin additives may be contained in the composition, or two or more of the resin additives may be contained therein in any combination at any ratio.

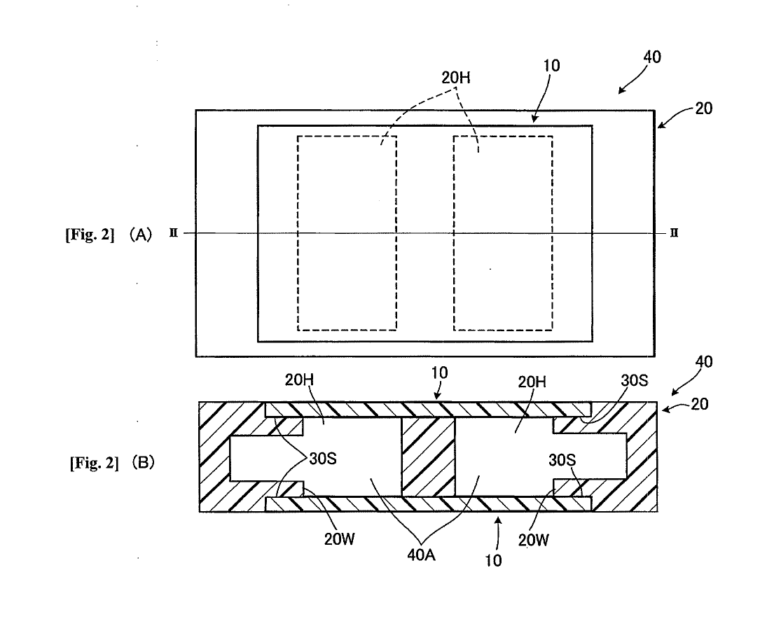

In one embodiment of the present invention as shown in FIG. 2, a laminate of a thermoplastic resin film 10 and a thermoplastic resin molded article 20 can be formed in a manner such that openings 20H of the thermoplastic resin molded article 20 are covered with the thermoplastic resin film 10. In this case, the thermoplastic resin film 10 is bonded to the thermoplastic resin molded article 20 by ultrasonic welding at a region where a welding surface 10S of the thermoplastic resin film 10 contacts with a welding surface 20S of the thermoplastic resin molded article 20 (see FIG. 1), i.e., a boundary surface 30S in FIG. 2.

The laminate 40 as a case thus produced can surely have internal spaces 40A wider than those obtained in the case where the whole surface is formed with a wall member 20W of the thermoplastic resin molded article 20 having a thickness larger than that of the thermoplastic resin film 10, and for example, spaces for housing internal components such as a battery are enlarged.

### EXAMPLES

Hereinafter, the present invention will be described in more detail by way of examples. However, the present invention is not limited to the below-described examples, and can be arbitrarily changed and then carried out without departing from the gist of the present invention.

### <Measurement of Thermal Deformation Temperature>

The thermal deformation temperature (Tg) of thermoplastic resin was measured by a differential scanning calorimetry SSC-5200 (DSC) manufactured by Seiko Instruments & Electronics Ltd. In the measurement, the temperature was elevated to a temperature at which the resin component was melted (260° C.) at a rate of 20° C./min under nitrogen atmosphere, rapidly cooled to −30° C., and then the temperature was elevated again at a rate of 10° C./min (2nd run). The glass transition temperature and the melting point were obtained from the obtained DSC curve based on the extrapolated onset temperature.

### <Welding Strength>

For evaluation of the ultrasonic welding strength, an opening portion of a molded article after welding of a film laminate was pressed by a finger from the molded article side and broken.

Particularly good: no break was observed in the welded portion.

Good: a break was partially observed in the welding margin.

Poor: the welded film was peeled off.

### <Evaluation of Outer Appearance>

Outer appearance of a molded article laminate after ultrasonic welding of a film laminate was visually evaluated. Visual observation was carried out from the film side. A particularly excellent state where there was almost no surface flaw on the film surface caused by pressing of a welding margin (energy director) was rated as particularly good, a good state where there were a few surface flaws was rated as good, a state where there was a rather noticeable surface flaw was rated as slightly poor, and a state where there was a large surface flaw, resulting in poor outer appearance was rated as poor.

### <Evaluation of Deflection>

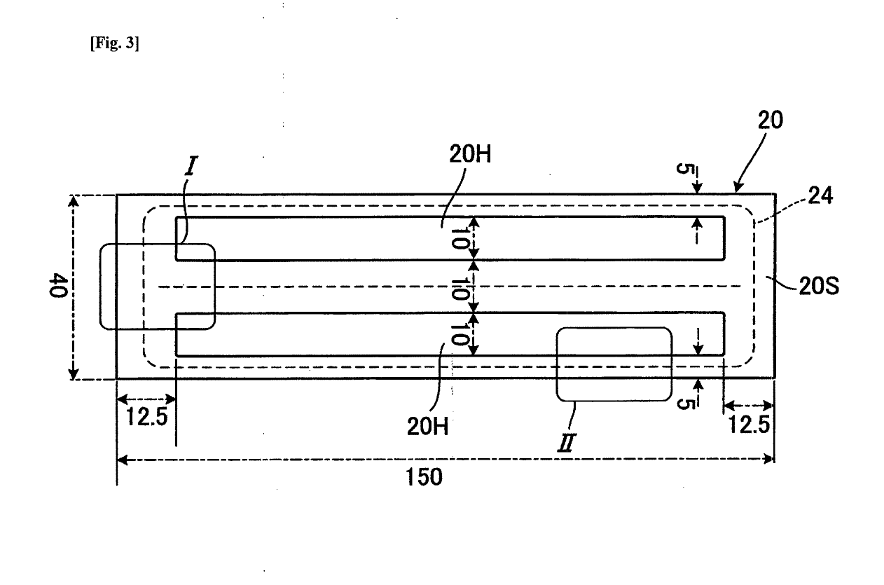

A film laminate was bonded, by welding, to a plate-like molded article having two openings and having a shape different from that of the molded article shown in FIGS. 1 and 2, as shown in FIG. 3, and after that, the degree of deflection of the molded article laminate was visually confirmed. A state where there was almost no deflection was rated as good, and a state where the degree of deflection was large was rated as poor.

### [Materials Used]

### <Thermoplastic Resins>

For a polycarbonate resin, compounding was carried out with a combination shown in Table 1, and as a polybutylene terephthalate, a commercially-available product was used.

(a-1) “Iupilon (registered trademark) S-3000F” manufactured by Mitsubishi Engineering-Plastics Corporation, bisphenol A-type aromatic polycarbonate resin, thermal deformation temperature (glass transition temperature): 145° C.
(a-2) “NOVADURAN (registered trademark) 5020” manufactured by Mitsubishi Engineering-Plastics Corporation, polybutyrene terephthalate resin, thermal deformation temperature (melting point): 224° C.
(a-3) “NOVADURAN (registered trademark) 5510S” manufactured by Mitsubishi Engineering-Plastics Corporation, polybutyrene terephthalate resin, thermal deformation temperature (melting point): 219° C.

### <Flame Retardant>

(b-1) “PX-200” manufactured by Daihachi Chemical Industry Co., Ltd., aromatic condensed phosphate ester-based flame retardant, 1,3-phenylene bis(di-2,6-xylenyl phosphate)

### Examples 1-10 and Comparative Examples 1-4

### <Production of Resin Pellet>

For compounding of a polycarbonate resin composition, a twin screw extruder having one vent, TEX30α (C18 block) manufactured by The Japan Steel Works, Ltd. was used. Further, components were kneaded at a screw rotation speed of 200 rpm, at a discharge rate of 20 kg/hour, and at a barrel temperature of 270° C., and the molten resin extruded into a strand-like shape was rapidly cooled in a water bath and pelletized using a pelletizer, thereby obtaining a compound of a polycarbonate resin composition.

### <Thermoplastic Resin Film (A)>

Using a T-die melt extruder composed of a twin screw extruder with a barrel diameter of 32 mm and screw L/D=35, a sheet having a width of 400 mm was formed at a discharge rate of 20 kg/hour and at a screw rotation speed of 200 rpm. The cylinder/die head temperature was set at 260° C. in the case of polycarbonate and at 235° C. in the case of polybutylene terephthalate. Regarding the surfaces of the film used, one surface was a mirror surface, and on the other surface, a mat pattern was transferred with a surface roughness Ra=1.5 μm. The film thickness was as shown in Table 1. Regarding the size of the film used in the ultrasonic welding test, the film was cut into a size of 150 mm×40 mm for covering the thermoplastic resin molded article (B) shown in FIG. 3.

### <Thermoplastic Resin Molded Article (B)>

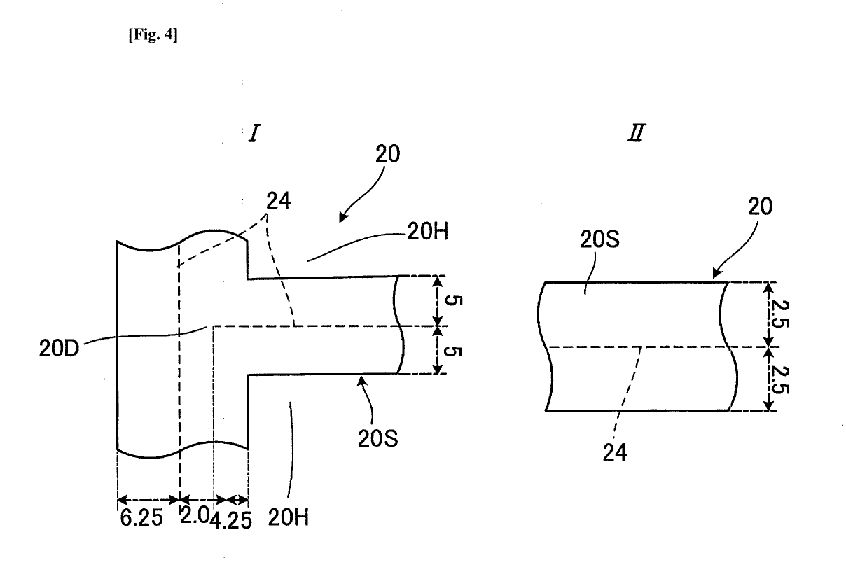

A flat resin plate with a size of 150 mm×100 mm×1.2 mm (thickness) made of a composition described in Table 1 was formed by injection molding. The obtained injection-molded article was subjected to cutting work, thereby producing a thermoplastic resin molded article (B) 20 having the size shown in FIG. 3 and having a welding margin (ED, energy director) (C) 24 with the shape schematically shown in FIG. 1. Note that numerical values different from the letters or numerals in FIGS. 3 and 4 are sizes of members (mm). These numerical values are examples of the sizes of members and do not limit the sizes.

<Resin Molded Article with Laminate>

A welding margin-integrated thermoplastic resin molded article, in which the above-described thermoplastic resin molded article (B) 20 and the thermoplastic resin film (A) 10 are provided in an integrated manner, was prepared. The height of the welding margin (ED, energy director) (C) was 0.1 to 0.4 mm as shown in Table 1. Further, using the thermoplastic resin molded article (B) 20 having the shape shown in FIG. 3, the thermoplastic resin film 10 was bonded, by welding, to the thermoplastic resin molded article 20 in a manner such that the two openings 20H were completely covered with the thermoplastic resin film. The thickness of the thermoplastic resin molded article (B) 20 was 1.0 mm, the lengths in the longitudinal and lateral directions thereof were respectively 4.0 cm and 15.0 cm, the lengths in the longitudinal and lateral directions of each of the openings 20H were respectively 1.0 cm and 12.5 cm, and the area of each of the openings 20H was 12.5 cm² (see FIG. 3). Further, a welding margin (C) 24 was provided to a position shown by a broken line on a welding surface 20S of the thermoplastic resin molded article (B) so as to surround the openings 20H. In FIG. 4, regions I and II of the welding surface 20S shown in FIG. 3 are enlarged.

By providing the welding margin (C) 24 in a manner such that substantially the whole circumference of the openings 20H is surrounded thereby in this way and performing ultrasonic welding, the thermoplastic resin film (A) 10 can be firmly fixed to the thermoplastic resin molded article (B) 20. Note that by providing a region 20D, in which the welding margin (C) 24 is discontinuous, in the region I of the welding surface 20S (see FIG. 4), processing for providing the welding margin can be more easily carried out.

TABLE 1

| | | | Example 1 | Example 2 | Example 3 | Example 4 | Example 5 | Example 6 | Example 7 | Example 8 | Example 9 | Example 10 |
|---|---|---|---|---|---|---|---|---|---|---|---|---|
| Resin film | Composition (wt %) | Aromatic polycarbonate resin | 90 | 90 | 90 | 90 | 90 | 90 | 90 | 90 | 90 | |
| (A) | | Thermal deformation temperature | | | | | | | | | | |
| | | (glass transition temperature) 145° C. | | | | | | | | | | |
| | | Aromatic condensed phosphate ester- | 10 | 10 | 10 | 10 | 10 | 10 | 10 | 10 | 10 | |
| | | based flame retardant | | | | | | | | | | |
| | | Polybutyrene terephthalate resin | | | | | | | | | | 100 |
| | | Thermal deformation temperature | | | | | | | | | | |
| | | (melting point) 224° C. | | | | | | | | | | |
| | Thickness, mm | | 0.2 | 0.2 | 0.2 | 0.1 | 0.1 | 0.4 | 0.4 | 0.2 | 0.2 | 0.2 |
| | Thermal deformation | | 114 | 114 | 115 | 115 | 1.15 | 115 | 115 | 115 | 115 | 224 |
| | temperature, ° C. | | | | | | | | | | | |
| Resin molded | Composition (wt %) | Aromatic polycarbonate resin | 90 | 90 | 90 | 90 | 90 | 90 | 90 | 92 | 96 | |
| article (B) | | Thermal deformation temperature | | | | | | | | | | |
| | | (glass transition temperature) 145° C. | | | | | | | | | | |
| | | Aromatic condensed phosphate ester- | 10 | 10 | 10 | 10 | 10 | 10 | 10 | 8 | 4 | |
| | | based flame retardant | | | | | | | | | | |
| | | Polybutyrene terephthalate resin | | | | | | | | | | 100 |
| | | Thermal deformation temperature | | | | | | | | | | |
| | | (melting point) 219° C. | | | | | | | | | | |
| | Thermal deformation | | 114 | 114 | 115 | 115 | 115 | 115 | 115 | 121 | 133 | 219 |
| | temperature, ° C. | | | | | | | | | | | |
| | Height (C) of welding margin | | 0.20 | 0.15 | 0.25 | 0.08 | 0.13 | 0.30 | 0.50 | 0.20 | 0.20 | 0.20 |
| | (ED), mm | | | | | | | | | | | |
| | Difference between thermal | \|A − B\| | 0 | 0 | 0 | 0 | 0 | 0 | 0 | 6 | 18 | 5 |
| | deformation temperatures, ° C. | | | | | | | | | | | |
| | Difference between film | (1 − C/A) × 100 | 0 | 25 | −25 | 25 | −25 | 25 | −25 | 0 | 0 | 0 |
| | thickness (A (mm)) and height | | | | | | | | | | | |
| | of welding margin (C (mm)) % | | | | | | | | | | | |
| Evaluation | Welding strength | | Particularly | Good | Good | Good | Good | Particularly | Particularly | Good | Good | Good |
| results | | | good | | | | | good | good | | | |
| | Presence or absence of | | Good | Particularly | Good | Good | Slightly | Particularly | Good | Good | Good | Good |
| | surface flaw | | | good | | | poor | good | | | | |
| | Deflection of film | | Good | Good | Particularly | Good | Good | Good | Good | Good | Good | Good |
| | | | | | good | | | | | | | |

### <In-Mold Film Molding>

An injection-molded article was formed using an in-mold film in order to compare an article made by ultrasonic welding with an injection-molded article formed using an in-mold film with respect to the state of deflection of the film covering the openings of the molded article. A polycarbonate resin film having the same size as that of the molded article for ultrasonic welding (150×40 mm) was set in a mold in advance, and injection molding of the polycarbonate resin was carried out using a mold which does not have engraving for forming the welding margin (C) of the mold for ultrasonic welding. Molding was carried out at a cylinder temperature of 320° C. and at a mold temperature of 95° C. The results obtained by in-mold film molding are shown in Comparative Example 4.

TABLE 2

| | | | Comparative | Comparative | Comparative | Comparative |
|---|---|---|---|---|---|---|
| | | | Example 1 | Example 2 | Example 3 | Example 4 (*) |
| Rein film | Composition (wt %) | Aromatic polycarbonate resin | 90 | 90 | 90 | 90 |
| (A) | | Thermal deformation temperature | | | | |
| | | (glass transition temperature) 145° C. | | | | |
| | | Aromatic condensed phosphate ester- | 10 | 10 | 10 | 10 |
| | | based flame retardant | | | | |
| | | Polybutyrene terephthalate resin | — | — | — | — |
| | | Thermal deformation temperature | | | | |
| | | (melting point) 224° C. | | | | |
| | Thickness, mm | | 0.2 | 0.2 | 0.2 | 0.2 |
| | Thermal deformation | | 115 | 115 | 115 | 114 |
| | temperarure, ° C. | | | | | |
| Resin | Composition (wt %) | Aromatic polycarbonate resin | 90 | 90 | 100 | 90 |
| molded | | Thermal deformation temperature | | | | |
| article (B) | | (glass transition temperature) 145°C. | | | | |
| | | Aromatic condensed phosphate ester- | 10 | 10 | — | 10 |
| | | based flame retardant | | | | |
| | | Polybutyrene terephthalate resin | — | — | — | — |
| | | Thermal deformation temperature | | | | |
| | | (melting point) 219° C. | | | | |
| | Thermal deformation | | 115 | 115 | 145 | 114 |
| | temperature, ° C. | | | | | |
| | Height (C) of welding | | 0.13 | 0.26 | 0.20 | — |
| | margin (ED), mm | | | | | |
| | Difference between | \|A − B\| | 0 | 0 | 30 | — |
| | thermal deformation | | | | | |
| | temperatures, ° C. | | | | | |
| | Difference between film | (1 − C/A) × 100 | 35 | −30 | 0 | — |
| | thickness (A (mm)) and height | | | | | |
| | of welding margin (C (mm)) % | | | | | |
| Evaluation | Welding strength | | Poor | Poor, film | Poor | Good |
| results | | | | was broken | | |
| | Presence or absence | | Good | Poor | Slightly | Absent |
| | of surface flaw | | | | poor | |
| | Deflection of film | | Good | Good | Good | Poor |

(*) In-mold film molding method

### <Ultrasonic Welding Method>

For ultrasonic welding, Branson 2000Xdt (20 kHz, 2200 W) manufactured by Emerson Japan, Ltd. was used, and a welding horn made of a titanium alloy suitable for the molded article shape was used. The welding test was carried out on the mirror surface of the thermoplastic resin film (A) and the surface of the thermoplastic resin molded article (B) on which the welding margin was formed. The welding test was carried out by fixing the thermoplastic resin molded article (B) to the upper horn side and fixing the thermoplastic resin film (A) to the lower horn receiving board. For protecting the mat pattern of the thermoplastic resin film (A), a protective film made of polyethylene having a thickness of 0.03 mm was brought into contact with the film to conduct the test. Parameters in the ultrasonic welding test were set as described below. Specifically, the ultrasonic welding test was carried out under conditions of irradiation time: 0.3 sec (0.45 sec in the case of polybutyrene terephthalate resin), hold time: 0.3 sec, air cylinder pressure: 200 kPa, trigger force: 250 N and amplitude: 100%.

In Examples 1-10 described above, all the welding strength and outer appearance and shape of the film were good or better than that, whereas in Comparative Examples 1-4, at least one of the evaluation results were inferior to the Examples. According to the results, it was confirmed that a laminate having higher welding strength and more excellent outer appearance compared to an article made by in-mold molding can be produced by ultrasonic welding, wherein a welding margin having an appropriate size is provided on a welding surface of a thermoplastic resin molded article, and wherein the difference between the thermal deformation temperature of a thermoplastic resin film and that of resin forming the thermoplastic resin molded article is adjusted to be smaller.

### REFERENCE SIGNS LIST

10 thermoplastic resin film
10T thickness of thermoplastic resin film
20 thermoplastic resin molded article
20H opening
20S welding surface
24 welding margin
24H height of welding margin

1. A thermoplastic resin film laminate, which is obtained by ultrasonic welding, a thermoplastic resin film having a thickness of 0.4 mm or less and a welding margin of a thermoplastic resin molded article having the welding margin and having a thickness of 0.5 mm or more,
wherein the height of the welding margin is 72 to 130% of the thickness of the thermoplastic resin film, and
wherein the difference between the thermal deformation temperature of the thermoplastic resin film and that of the thermoplastic resin molded article is 20° C. or less.

2. The thermoplastic resin film laminate according to claim 1, wherein the thermoplastic resin film and the thermoplastic resin molded article are formed with the same type of resin materials.

3. The thermoplastic resin film laminate according to claim 1, wherein the thermoplastic resin film has a thickness of 0.2 mm to 0.3 mm.

4. The thermoplastic resin film laminate according to claim 1, wherein the thermoplastic resin molded article has at least one opening of 3 cm² or more, and wherein at least a part of the opening is covered with the thermoplastic resin film.

5. A molded article comprising the thermoplastic resin film laminate according to claim 1.
